(19) United States
(12) Patent Application Publication
(10) Pub. No.: US 2024/0039757 A1
(43) Pub. Date: Feb. 1, 2024

(54) COMMUNICATION METHODS, VIRTUAL PROXYS AND COMPUTER SYSTEM FOR IMPLEMENTING SUCH METHODS

(71) Applicant: Orange, Issy-les-Moulineaux (FR)

(72) Inventor: Benoît Lemoine, Châtillon Cedex (FR)

(21) Appl. No.: 18/258,693

(22) PCT Filed: Dec. 10, 2021
(86) PCT No.: PCT/FR2021/052274

§ 371 Date: Jun. 21, 2023

(30) Foreign Application Priority Data
Dec. 23, 2020 (FR) FR2014054

(51) Int. Cl. H04L 12/46; H04L 45/50; H04L 45/745

(52) U.S. Cl. CPC H04L 12/4633; H04L 45/50; H04L 45/745; H04L 2212/00

(57) ABSTRACT

A communication method is disclosed, implemented by a virtual source proxy, belonging to a computer system comprising a virtualization management system, a server, in which the source proxy and a source host are connected, another server, in which a virtual destination proxy and a destination host are connected. The method comprises running a request to configure, on a private network of the source host, a virtual interface, the request comprising a demand to associate a hardware address of the source host with an identifier associated with an identifier of the private network, sending the destination proxy an address resolution request transmitted by the source host, and sending the source host a response to said resolution request, the response comprising a hardware address of the destination host.

### PRIOR ART

This invention relates to the general field of telecommunications. It more specifically relates to communication methods implemented by entities of a computer system implementing a switching virtual local network, and also the entities and the computer system in question. The invention finds a particularly advantageous, though in no way limiting, application in the context of a small or medium-sized data center, so substantially of a maximum of one hundred machines.

Computer virtualization technology is well-known at present. In its general principle, it consists in creating and executing, on a virtualization platform (currently known as a “host machine”), one or more virtual representations of a computer or of its different resources, such as for example an operating system, a server, an office, a storage system, a network etc. These simulated resources are in all aspects identical to their physical versions located on the client side.

Such a virtualization platform can for example include a plurality of layers, including in particular:
a virtualization or hypervisor layer, and
a layer of one or more virtual machines, each virtual machine executing a single instance of an operating system, known as a guest operating system, and operating independently of the other virtual machines of the virtualization platform.
   The automated deployment of the virtual machines on the virtualization layer is ensured by a Virtual Machine Manager.

Note that the virtualization technology is not limited to the implementation of virtual machines but also relates, in a manner known per se, to the implementation of sets of containers (also known as “pods”).

Furthermore, virtualization technology can come in several types, such as for example the virtualization of servers and networks, now increasingly in use. This is particularly the case of an increasing number of businesses seeking to concentrate their computer resources in datacenters and thus optimize their virtual computing/processing power, also known by the name “cloud computing”

Also, to support the development of server and network virtualization technology, telecommunications operators have changed their practices. More specifically, these operators until now used physical telecommunications equipment, based on specialized ASIC (Application Specific Integrated Circuit) processors, and physically connected to virtual private networks or VPN) via dedicated interfaces on IP/MPLS routers (IP for Internet Protocol and MPLS for Multi Protocol Label Switching) implementing these VPNs.

Henceforth, said operators are making developments to implement telecommunication services based on Virtual Network Functions or VNFs, which can be more accurately described as software components deployed on virtual machines or on containers in a set of virtualized computer servers. This is for example the case of elementary virtual network functions such as virtual Ethernet bridges (examples: Linux bridge, or else virtual Ethernet switches such as for example OpenVSwitch switches) or else more sophisticated virtual network functions such as mobile network gateways (e.g. Packet Data Network Gateway for 4G mobile networks or User Plane Function for 5G mobile networks).

To connect to a same VLAN (Virtual Local Area Network) Ethernet switching network set up through a datacenter, virtual Ethernet interfaces of VNFs defined over several VPNs of IP/MPLS networks, the solutions deployed until now have the common point of relying on a computer architecture implementing, in each server of the datacenter, a router, known by the name of “PE” (Provider Edge) router, which makes it possible to connect one or more virtual machines, also known as “CE” (Customer Edge) hosts, to the VPNs in question.

Hence, to transport the traffic coming from a source CE host to a destination CE host in an isolated manner in a VPN, the source PE router associated with said source CE host must use a VPN tunnel toward the remote PE router associated with said destination CE host. More specifically, the traffic coming from a source CE host is inserted (encapsulated) into a tunnel by the source PE router, the destination PE router having the function of extracting this traffic from the tunnel so that it can be transmitted to the destination CE host.

Such an implementation, common to solutions of the prior art, has several consequences. Specifically, and firstly, the transmission of traffic through tunnels implies that the source PE router must identify the destination PE router to which the destination CE host is connected. To do this, a switching table associating the addresses of each remote CE host and of the remote PE router attached to this latter is implemented at the level of the source PE router. The result of these considerations is that the source PE router must update the switching table each time a remote host is identified.

Secondly, it is obvious that there is no simple way of inserting (encapsulating) traffic into VPN tunnels, and that not all the solutions that can be implemented are compatible with one another. The result of this is that for a telecommunications operator, a hard limit is placed on the possibility of offering mix-and-match solutions of different service providers within one datacenter.

The end result of the above is that the use of PE routers in servers of a datacenter poses disadvantages in terms of implementation complexity, thus making it difficult to guarantee transfer flow rate performances and also to guarantee fault-free operation. Moreover, this complexity itself incurs a considerable implementation cost which proves incompatible with the current trend towards the concentration of computer resources in datacenters.

### SUMMARY OF THE INVENTION

This invention has the aim of remedying all or part of the drawbacks of the prior art, particularly those set out above, by proposing a solution which makes it possible to connect interfaces of VNFs defined over several VPNs of IP/MPLS networks to a same Ethernet VLAN switching network of the virtual Ethernet, more simply and less expensively than solutions of the prior art, such as to be able to guarantee transfer flow rate performances and also fault-free operation.

For this purpose, and according to a first aspect, the invention relates to a communication method, the so-called “first method”, implemented by a multiprotocol label switching virtual proxy, the so-called “source proxy”, belonging to a computer system implementing a switching virtual local network, said computer system further including a virtualization management system, a first server wherein said proxy source and a so-called “host source” are connected, a second server wherein a multiprotocol label switching virtual proxy, the so-called “destination proxy” and a host, the so-called “destination host” are connected, said source and destination proxies being connected to the local network and also attached to a communication virtual private network. Said first method includes steps of:
running (or executing) a request received from the virtualization management system to configure, on said private network, a virtual interface for said source host, said request including a request for association of a hardware address of the source host with an identifier, the so-called “tunnel identifier” associated with an identifier of said private network,
transmitting, to the destination proxy, a request sent by the source host, said request being an address resolution request for an IP address of the destination host,
transmitting, to the source host, a reply to said resolution request, said reply being sent by the destination host and received from the destination proxy, and also including a hardware address of said destination host.

Fundamentally, the first method according to the invention is differentiated from the prior art in that the PE router functions in computer servers are here replaced by proxy functions.

The result of this is that said first method makes it possible to configure the computer system such that the source proxy has for only knowledge, as next hop address, the hardware address of the source host. Since the IP address resolution requests are requests addressed to all the IP hosts over the local virtual switching network, the source proxy can relay them without knowing the hardware address of the destination host. Since the IP address resolution replies are replies addressed to the hardware address of the source host, the source proxy can relay them based solely on the knowledge of the association between the hardware address of the source host and the virtual interface to which it is connected. In this way, the source host is able to retrieve the hardware address of the destination host without approaching the source proxy and by connecting the destination host bearing this next hop IP address to the same switching virtual local network as that to which the interface of the host source is connected.

Said first method moreover makes provision for the tunnel identifier to be identical for all the virtual Ethernet interfaces of VNFs defined on the same private network, which makes it possible to configure this latter a single time per virtual Ethernet interface in the source proxy, at the time of the connection of said source host to said source proxy. Such provisions are particularly advantageous since the tunnel identifier does not depend here on the destination host, thus facilitating the connection of virtual Ethernet interfaces of VNFs defined over several VPNs.

Note that the invention has a particularly advantageous, although in no way limiting, application in the context of a computer system implemented in a datacenter of small or medium size, so substantially one hundred machines maximum, in such a way that Ethernet switches connecting the servers inside the computer system are capable of processing all the Ethernet addresses exposed on the local virtual switching network.

In particular implementations, the first communication method can moreover include one or more of the following features, taken in isolation or in any technical possible combination.

In particular implementations, said first method further includes steps of:
receiving, from the source host, an Ethernet frame encapsulating an IP packet sent by the source host toward the destination host, said Ethernet frame including the respective hardware addresses of the source and destination hosts,
inserting the tunnel identifier into the Ethernet frame between said hardware addresses and the IP packet,
transmitting said Ethernet frame to the destination proxy.

Such provisions allow the source proxy to have the source host passed to the destination proxy as being the source of a VPN tunnel. Reciprocally, the destination proxy is able to have the destination host passed to the source proxy as being the destination of a VPN tunnel. In other words, said source and destination proxies here appear, owing to the invention, as endpoints of a VPN tunnel.

In particular implementations, the tunnel identifier is identical to the identifier of the private network.

In particular implementations, the tunnel identifier is contained in a data table matching the identifier of the private network with said tunnel identifier.

According to a second aspect, the invention relates to a communication method, said “second method”, implemented by a multiprotocol label switching virtual proxy, the so-called “destination proxy”, belonging to a computer system implementing a switching virtual local network, said computer system further including a virtualization management system, a first server wherein a multiprotocol label switching virtual proxy, the so-called “source proxy”, and a host, the so-called “source host”, are connected, a second server wherein said destination proxy and also a so-called “destination host” are connected, said source and destination proxies being connected to the local network and also attached to a communication virtual private network. Said second method includes steps of:
transmitting to the destination host a received request coming from the source proxy and sent by the source host, said request being an address resolution request for an IP address of the destination host,
transmitting to the source proxy a reply to said resolution request, said reply being sent by the destination host and including a hardware address of said destination host.

Said second method inherits the same advantages as those mentioned above with reference to said first method.

In particular implementations, the second communication method can further include one or more of the following features, taken in isolation or according to any technically possible combination.

In particular modes of implementation, said second method further includes steps of:
receiving, from the proxy source, an Ethernet frame encapsulating an IP packet, said Ethernet frame including the following respective hardware addresses of the source and destination hosts,
checking a match between, on the one hand, a first identifier, the so-called “tunnel identifier”, inserted between said hardware addresses and the IP packet, and, on the other, a second identifier contained in a data table matching the hardware address of the destination host with said second identifier,
if the match check is positive, removing the tunnel identifier from said Ethernet frame and transmitting the Ethernet frame to the destination host.

In particular implementations of said first and second methods, a data table containing an identifier used by a proxy is a switching table stored by said proxy.

In particular implementations of said first and second methods, a data table containing an identifier used by a proxy is a switching table stored by a virtual Ethernet bridge to which is connected the host contained in the server hosting said proxy.

According to a third aspect, the invention relates to a computer program including instructions for implementing a first method according to the invention or a second method according to the invention when said program is executed by a computer.

This program can use any programming language, and be in the form of source code, object code, or intermediate code between source code and object code, such as in a partially compiled form, or in any other desirable form.

According to a fourth aspect, the invention relates to an information or recording medium readable by a computer, and on which is recorded a computer program according to the invention.

The information or recording medium can be any entity or device capable of storing the program. For example, the medium can include a storage medium, such as a ROM, for example a CD-ROM or a microelectronic circuit ROM, or else a magnetic recording medium, for example a diskette (floppy disk) or a hard disk.

Moreover, the information or recording medium can be a transmissible medium such as an electrical or optical signal, which can be conveyed via an electrical or optical cable, by radio or by other means. The program according to the invention can in particular be downloaded over a network of Internet type.

Alternatively, the information or recording medium can be an integrated circuit wherein the program is incorporated, the circuit being adapted to be executed or to be used in the execution of the method in question.

According to a fifth aspect, the invention relates to a multiprotocol label switching virtual proxy, the so-called “source proxy”, including means configured to implement a first method according to the invention.

According to a sixth aspect, the invention relates to a multiprotocol label switching virtual proxy, the so-called “destination proxy”, including means configured to implement a second method according to the invention.

According to a seventh aspect, the invention relates to a computer system implementing a switching virtual local network, said computer system including a virtualization management system, a first server wherein a source proxy according to the invention and a so-called “source host” are connected, a second server wherein a destination proxy according to the invention and a host, the so-called “destination host”, are connected, said first and second servers being connected to the local network and also attached to a communication virtual private network.

### BRIEF DESCRIPTION OF THE DRAWINGS

Other features and advantages of this invention will become apparent from the description given below, with reference to the appended drawings which illustrate an exemplary embodiment therefore without any limitation. In the figures:

FIG. 1 schematically represents, in its environment, a particular implementation of a computer system according to the invention;

FIG. 2 schematically represents an example of hardware architecture of a virtual proxy according to the invention, the so-called “source proxy”, belonging to the computer system of FIG. 1;

FIG. 3 schematically represents an example of hardware architecture of a virtual proxy according to the invention, the so-called “destination proxy”, belonging to the computer system of FIG. 1;

FIG. 4 represents, in the form of a flow chart, a particular implementation of a communication method, the so-called “general method”, implemented by the computer system of FIG. 1, said general method, implemented by the computer system of FIG. 1, said general method encompassing a first method according to the invention and a second method according to the invention respectively implemented by the source proxy of FIG. 2 and the destination proxy of FIG. 3;

FIG. 5 schematically represents an Ethernet frame transmitted by the source proxy of FIG. 2 to the destination proxy of FIG. 3 when implementing the general method of FIG. 4.

### DESCRIPTION OF THE EMBODIMENTS

FIG. 1 schematically represents, in its environment, a particular implementation of a computer system SI according to the invention.

In the implementation of FIG. 1, the computer system SI is arranged in a datacenter DC and implements an Ethernet switching network corresponding to a VLAN switching virtual local network. Such a VLAN virtual network corresponds, in a manner known per se and with reference to the naming conventions of the OSI (Open Systems Interconnection) model, to a level 2 network used to segment the traffic exchanged over this network according to the hardware addresses, the so-called “MAC (Media Access Control) addresses”, of devices owned by users.

The computer system SI is configured to implement a virtualization of interconnected servers via the virtual network VLAN. For this purpose, and as illustrated in the embodiment of FIG. 1, the computer system SI includes a virtualization management system SGV which comprises, in a manner known per se:
a local network managing device, the so-called “VNM (Virtual Network Manager) device”. It is an entity configured to manage the creation of virtual interfaces on virtual switching elements (software programs in the operating system, or hardware in the network interface cards) of computer servers;
a virtual infrastructure managing device, the so-called “VIM (Virtual Infrastructure Manager) device”. This is an entity configured to manage the creation of virtual machines or sets of containers in a computer server.

In this implementation, the computer system SI also includes two computer servers, namely:
a first server SERV-1 wherein are connected a multiprotocol label switching virtual proxy, the so-called “source proxy” PR-S, and a host, the so-called “source host” CE-S. Said source proxy PR-S is a proxy using the MPLS (Multi Label Protocol Switching) transport mechanism;
a second server SERV-2 wherein are connected a virtual proxy MPLS, the so-called “destination proxy” PR-D1, and a host, the so-called “destination host” CE-D1. Said destination proxy PR-D1 is a proxy using the transportation mechanism MPLS.

Said source PR-S and destination PR-D1 proxies are moreover connected to the local network VLAN.

Although it is considered in FIG. 1 that the computer system SI includes only two servers, including a single one including a source proxy/host and a simple one including a destination proxy/host), it should be noted that this is only a particular implementation of the invention with the aim of simplifying its description. The fact remains that other variant implementations can be envisioned, such as for example a single server including a source proxy/host and a plurality of servers each including a destination proxy/host, or else a plurality of servers each including a source proxy/host and a single server including a destination proxy/host, or yet again a plurality of servers each including a source proxy/host and a plurality of servers each including a destination proxy/host.

In general, no limitation is attached to the number of servers each including a source proxy/host and to the number of servers each including a destination proxy/host. Of course, neither is any limitation attached to the number of hosts that can be incorporated into a server. For example, a server can host several sources or several destination hosts, or yet again a source host and a destination host, or yet again one or more source hosts and one or more destination hosts.

Finally, no limitation is attached to the number of virtual private networks VPN to which the proxies can be attached. For example, a server may host several source hosts for which a proxy must store in the memory a different identifier for their virtual Ethernet interfaces (here this is an identifier, the so-called “tunnel identifier” as will be described in detail further on).

In accordance with the invention, the source proxy PR-S is configured to carry out processing allowing the source host CE-S to communicate with the destination host CE-D1 within a given communication virtual private network VPN, via the sending of Ethernet frames, and implementing a communication method, the so-called “first method” according to the invention.

The destination proxy PR-D1 is meanwhile configured to carry out processing allowing the destination host CE-D1 to communicate with the source host CE-S within said given virtual private network VPN, via the receipt of Ethernet frames, and implementing a communication method, the so-called “second method” according to the invention.

Note then that for the implementation of said first and second methods, it is considered that said source PR-S and destination PR-D1 proxies are attached to the same given private network VPN such as to allow the source CE-S and destination CE-D1 hosts to communicate with one another.

Conventionally, each host contained in a server is associated with a MAC hardware address and also with an IP address. The way in which a MAC hardware address can be assigned to a host is detailed further on.

Each private virtual network is also associated with an identifier making it possible to distinguish it among other virtual private networks.

For the rest of the description, the notations are used according to which the MAC addresses of the source CE-S and destination CE-D1 hosts are respectively referred to as CE-S MAC@ and CE-D1 MAC@. The notation is also used according to which the IP address of the destination host CE-D1 is referred to as CE-D1 NH@. Finally, the identifier of the virtual private network VPN associated with the source CE-S and destination CE-D1 hosts is meanwhile written VPN-ID.

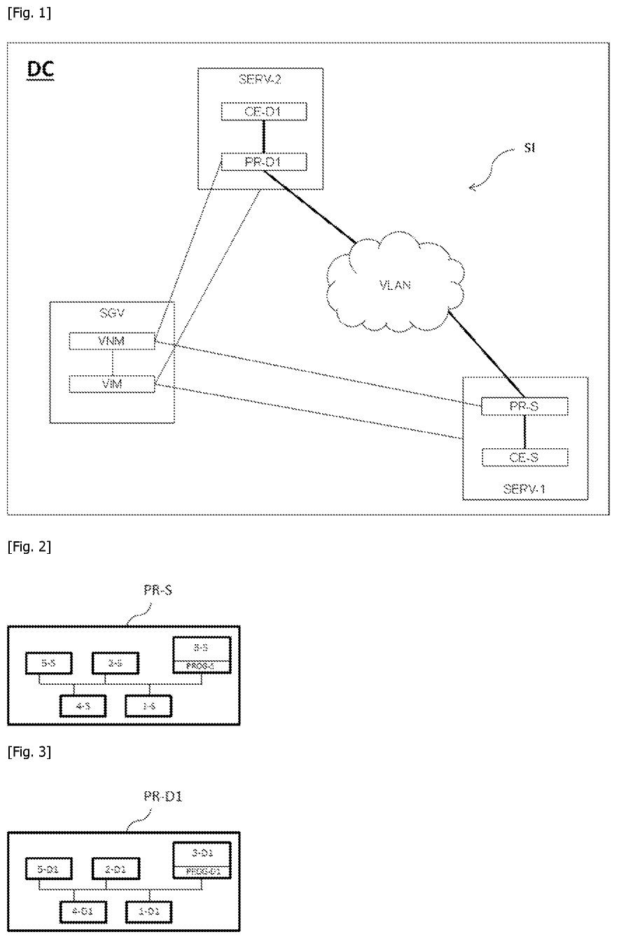

FIG. 2 schematically represents an example of a hardware architecture of the source proxy PR-S belonging to the computer system SI of FIG. 1, for implementing the first method according to the invention.

As illustrated by FIG. 2, the source proxy PR-S possesses the hardware architecture of a computer. Thus, the source proxy PR-S includes, in particular, a processor 1-S, a random access memory 2-S, a read-only memory 3-S and a non-volatile memory 4-S. It further includes a communication module 5-S.

The read-only memory 3-S of the source proxy PR-S constitutes a recording medium in accordance with the invention, readable by the processor 1-S and on which is recorded a computer program PROG-S in accordance with the invention, including instructions for executing steps of the first method. The program PROG-S defines functional modules (in this case, these are software modules) of the source proxy PR-S, which rely on or control the hardware elements 1-S to 5-S of the source proxy PR-S previously mentioned, and which particularly comprise:
an executing module MOD_EXE-S configured to run (or execute) a request received from the virtualization management system SGV, said request being set up such as to configure, on the private network VPN, a virtual interface for the source host CE-S. For this purpose, said interface includes a request for association of the hardware address CE-S MAC@ with an identifier, the so-called “tunnel identifier” Tunnel-ID, associated with the identifier VPN-ID,
a first transmitting module MOD_TX1-S configured to transmit to the destination proxy PR-D1 a request sent by the source host CE-S, said request being an address resolution request for the address CE-D1 NH@,
a second transmitting module MOD_TX2-S configured to transmit to the source host CE-S a reply to said resolution request, said reply being sent by the destination host CE-D1 and received from the destination proxy PR-D1, and also including the hardware address CE-D1 MAC@,
a receiving module MOD_RX-S configured to receive, from the source host CE-S, an Ethernet frame encapsulating an IP packet sent by the source host CE-S toward the destination host CE-D1, said Ethernet frame including hardware addresses CE-S MAC@ and CE-D1 MAC@,
an inserting module MOD_INSERT-S configured to insert, into the Ethernet frame, the tunnel identifier between said hardware addresses CE-S MAC@, CE-D1 MAC@ and the IP packet,
a third transmitting module MOD_TX3-S configured to transmit said Ethernet frame to the destination proxy PR-D1.

The communication module 5-S allows the source proxy PR-S to communicate with other entities of the computer system SI, particularly the source host CE-S, the device VNM and the destination proxy PR-D1. It can for example comprise a virtual network card or any other means making it possible to connect to the local network VLAN. Said communication module 5-S particularly incorporates said first, second and third transmitting modules MOD_TX1-S, MOD_TX2-S, MOD_TX3-S and also the receiving module MOD_RX-S.

It should be noted that the tunnel identifier Tunnel-ID corresponds, in this embodiment, to an MPLS label and can be determined in different ways.

Thus, and according to a first exemplary embodiment, the tunnel identifier Tunnel-ID is identical to the identifier VPN-ID of the private network VPN.

According to a second exemplary embodiment, the tunnel identifier Tunnel-ID is contained in a data table matching the identifier VPN-ID of the private network VPN with said tunnel identifier Tunnel-ID. In other words, in this second example, said data table is a table taking as input private network identifiers (including the identifier VPN-ID) and supplying as output tunnel identifiers respectively associated with said private network identifiers.

Said data table for example corresponds to a switching table stored by the source proxy PR-S, or else, alternatively, to a switching table stored by a virtual Ethernet bridge to which is connected the source host CE-S contained in the server SERV-1 hosting said source proxy PR-S.

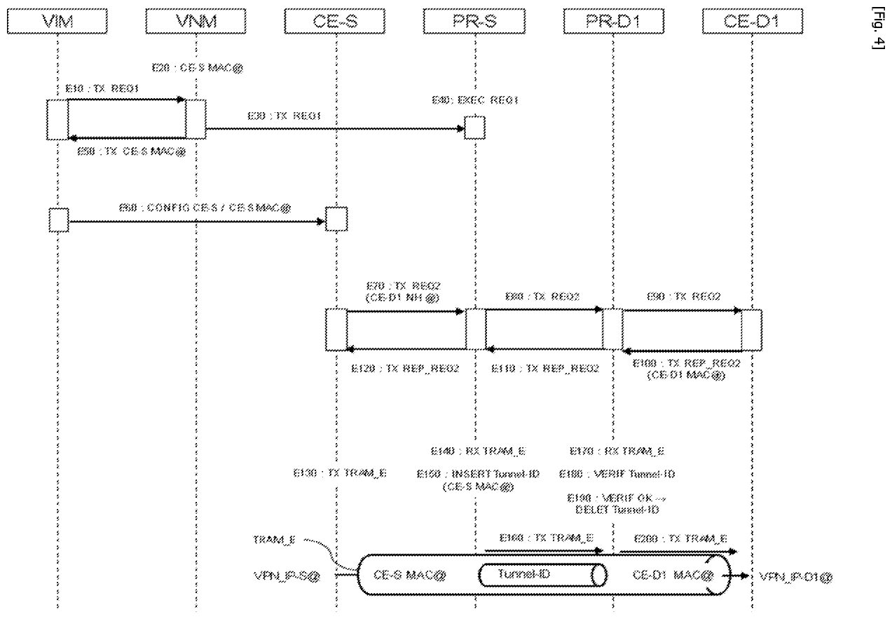

FIG. 3 schematically represents an example of hardware architecture of the destination proxy PR-D1 belonging to the computer system SI of FIG. 1, for implementing the second method according to the invention.

As illustrated by FIG. 3, the destination proxy PR-D1 possesses the hardware architecture of a computer. Thus, the destination proxy PR-D1 includes, in particular, a processor 1-D1, a random-access memory 2-D1, a read-only memory 3-D1 and a non-volatile memory 4-D1. It further includes a communication module 5-D1.

The read-only memory 3-D1 of the destination proxy PR-D1 constitutes a recording medium in accordance with the invention, readable by the processor 1-D1 and on which is recorded a computer program PROG-D1 in accordance with the invention, including instructions for executing the steps of the second method. The program PROG-D1 defines functional modules (in this case, these are software modules) of the destination proxy PR-D1, which rely on or control the hardware elements 1-D1 to 5-D1 of the destination proxy PR-D1 previously mentioned, and which particularly comprise:
a first transmitting module MOD_TX1-D1 configured to transmit to the destination host CE-D1 a request received from the source proxy PR-S and sent by the source host CE-S, said request being an address resolution request for the address CE-D1 NH@,
a second transmitting module MOD_TX2-D1 configured to transmit to the source proxy PR-S a reply to said resolution request, said reply being sent by the destination host CE-D1 and including the hardware address CE-D1 MAC@,
a receiving module MOD_RX-D1 configured to receive, from the source proxy PR-S, an Ethernet frame encapsulating an IP packet sent by the source host toward the destination host, said Ethernet frame including the hardware addresses CE-S MAC@ and CE-D1 MAC@,
a checking module MOD_VERIF-D1 configured to check a match between, on the one hand, a first identifier, the so-called “tunnel identifier”, inserted between said hardware addresses CE-S MAC@, CE-D1 MAC@ and the IP packet, and, on the other hand, a second identifier contained in a data table matching the hardware address CE-D1 MAC@ with said second identifier. Note that in practice, the tunnel identifier under consideration here matches a tunnel identifier Tunnel-ID inserted by the source proxy PR-S into said Ethernet frame by means of its inserting module MOD_INSERT-S,
a removing module MOD_DELETE-D1 configured to remove the tunnel identifier from the received Ethernet frame if the match check is positive,
a third transmitting module MOD_TX3-D1 configured to transmit the Ethernet frame to the destination host CE-D1 if the match check is positive and after the tunnel identifier has been removed.

The communication module 5-D1 allows the destination proxy PR-D1 to communicate with other entities of the computer system SI, in particular the source host CE-S, the device VNM and the source proxy PR-S. It may for example comprise a virtual network card or any other means making it possible to connect to the local network VLAN. Said communication module 5-D1 particularly incorporates said first, second and third transmitting modules MOD_TX1-D1, MOD_TX2-D1, MOD_TX3-D1 and also the receiving module MOD_RX-D1.

It should be noted that, according to dispositions similar to those described above as regards the possibilities of determination of the tunnel identifier Tunnel-ID, the data table used by the checking module MOD_VERIF-D1 can for example correspond to a switched table stored by the destination proxy PR-D1, or yet again to a switching table stored by a virtual Ethernet bridge to which is connected the destination host CE-D1 contained in the server SERV-2 hosting said destination proxy PR-D1.

FIG. 4 shows, in the form of a flow chart, a particular implementation of a communication method, the so-called “general method”, implemented by the computer system SI. Said general method encompasses said first and second methods according to the invention respectively implemented by the source proxy PR-S of FIG. 2 and the destination proxy PR-D1 of FIG. 3.

As illustrated by FIG. 4, said general method firstly includes a step E10 of sending a request REQ1 via the device VIM. Said request REQ1 is set up so as to configure, on the private network VPN and at the level of the source proxy PR-S, a virtual interface for the source host CE-S.

On receiving the request REQ1, the device VNM chooses a MAC hardware address for the source host CE-S during a step E20 of said general method. In this implementation, said MAC hardware address is denoted CE-S MAC@, in accordance with the notation previously introduced.

Once the address CE-S MAC@ is chosen, said general method includes a step E30 of transmitting the request REQ1, from the device VNM to the source proxy PR-S. Given that a MAC hardware address has been chosen for the source host CE-S, said request REQ1 now includes a request for association of the hardware address CE-S MAC@ with a tunnel identifier Tunnel-ID associated with the identifier VPN-ID.

According to this implementation, said identifier Tunnel-ID is contained in a data table TAB-S stored by the source proxy PR-S, said table TAB-S matching the VPN-ID of the private network VPN with said tunnel identifier Tunnel-ID.

Following the transmission of said request REQ1 to the source proxy PR-S, the general method includes a step E40 of executing the request REQ1 by the source proxy PR-S. More specifically, said step E40 is implemented by the executing module MOD_EXE-S equipping the source proxy PR-S and is an integral part, in this implementation, of said first method.

Note that once the hardware address CE-S MAC@ is chosen by the device VNM, it is communicated to the device VIM by said device VNM. This is the subject of a step E50 of the general method, as illustrated by FIG. 4. Hence, the device VIM is able to configure the source host CE-S with the address CE-S MAC@ (i.e. assign to the source host CE-S the address CE-S MAC@) which has been chosen by the device VNM, which is the subject of a step E60 of the general method.

In the implementation illustrated by FIG. 4, the general method also includes a step E70 of sending a request REQ2 via the source host CE-S. Said request is an address resolution request for the IP address CE-D1 NH@.

Note that the sending of the request is done in accordance with an address resolution protocol “ARP” (Address Resolution Protocol) in the case of IPv4 addresses, or else in accordance with an address resolution protocol “ICMPv6” (Internet Control Message Protocol version 6) in the case of IPv6 addresses, both known to those skilled in the art as hardware address resolution protocols usable within a switching virtual local network VLAN.

Also, on receiving the request REQ2, the source proxy PR-S transmits said request REQ2 to the destination proxy PR-D1 during a step E80 of the general method. More specifically, said step E80 is implemented by the first transmitting module MOD_TX1-S equipping the source proxy PR-S and is an integral part, in this implementation, of said first method.

On receiving the request REQ2, the destination proxy PR-D1 transmits said request REQ2 to the destination host CE-D1 during a step E90 of the general method. More specifically, said step E90 is implemented by a first transmitting module MOD_TX1-D1 equipping the destination proxy PR-D1 and is an integral part, in this implementation, of said second method.

On receiving the request REQ2, the destination host CE-D1 replies to said request REQ2 by transmitting, during a step E100 of the general method, a reply REP_REQ2 to the destination proxy PR-D1, said reply including the hardware address CE-D1 MAC@.

Note that the assignment of the address CE-D1 MAC@ to the destination host can, according to a particular exemplary implementation of the general method (example not shown on FIG. 4), be the subject of a similar procedure to that described hereinabove for assigning the address CE-S MAC@ to the source host CE-S. In other words, according to such an example, similar steps to steps E10 to E60 described hereinabove may be applied, such that the destination host CE-D1 is finally configured with said hardware address CE-D1 MAC@.

Of course, the fact of considering such an exemplary determination of the address CE-D1 MAC@ constitutes only one variant implementation of the invention. Also, nothing precludes said address CE-D1 MAC@ from being determined prior to the implementation of the general method according to any method known to those skilled in the art.

On receiving said reply REP_REQ2, the destination proxy PR-D1 transmits said reply REP_REQ2 to the source proxy PR-S during a step E110 of the general method. More specifically, said step E110 is implemented by the second transmitting module MOD_TX2-D1 equipping the destination proxy PR-D1 and is an integral part, in this implementation, of said second method.

On receiving said reply REP_REQ2, the source proxy PR-S transmits said reply REP_REQ2 to the source host CE-S during a step E120 of the general method. More specifically, said step E120 is implemented by the second transmitting module MOD_TX2-S equipping the source proxy PR-S and is an integral part, in this implementation, of said first method.

It should be noted that the general method is here described according to an implementation for which the computer system SI includes only a single destination proxy (in this case, it is the destination proxy PR-D1 of FIGS. 1 and 3). It can however be observed that if said computer system SI includes a plurality of destination proxies, the request REQ2 sent by the source host CE-S (step E70) and received by the source proxy PR-S is transmitted by the latter to the set of destination proxies. Of course, insofar as this request REQ2 relates to an address resolution for the IP address CE-D1 NH@, only the destination host CE-D1 replies to it.

Moreover, in the implementation illustrated by FIG. 4, the general method also includes a step E130 of sending, by the source host CE-S and toward the destination host CE-D1, an IP packet within an Ethernet frame TRAM_E. Thus, said Ethernet frame TRAM_E encapsulates said IP packet sent by the source host CE-S, and here includes the hardware addresses CE-S MAC@ and CE-D1 MAC@ which therefore respectively form source and destination addresses of the frame TRAM_E.

The source IP address attached to this IP packet is denoted VPN_IP-S@ in FIG. 4.

The general method then includes a step E140 of receiving, from the source host CE-S, the frame TRAM_E by the source proxy PR-S. More specifically, said step E140 is implemented by the receiving module MOD_RX-S equipping the source proxy PR-S and is an integral part, in this implementation, of said first method.

On receiving the frame TRAM_E, the source proxy PR-S inserts into said frame TRAM_E, and during a step E150 of the general method, the tunnel identifier Tunnel-ID between the hardware addresses CE-S MAC@, CE-D1 MAC@ and the IP packet. More specifically, said step E150 is implemented by the inserting module MOD_INSERT-S equipping the source proxy PR-S and is an integral part, in this implementation, of said first method.

The insertion of the identifier Tunnel-ID into the frame TRAM_E is symbolized in FIG. 4 by the fact that said identifier Tunnel-ID defines an MPLS tunnel placed inside the frame TRAM-E. The source proxy PR-S thus forms an endpoint of said MPLS tunnel, which is also the case of the destination proxy PR-D1 as is described hereinafter.

Note that if the IP packet encapsulated into the frame TRAM_E is compliant with an IPv6 packet, it can be checked, before inserting the tunnel identifier Tunnel-ID and following a particular exemplary embodiment, that said IP packet does not include a message (request or reply) for resolution of an ICMPv6 address. Such a check is here performed by the inserting module MOD_INSER-S in this special case of implementation.

However, the choice consisting in carrying out such a check only constitutes a variant of implementation of the step E150, and it is of course possible to envision yet other variants.

Specifically, unlike the IP packets, which have the purpose of being transferred by a router from a VLAN to another VLAN, the hardware address resolution messages can only be exchanged inside a switching local network VLAN. Also, for next hop IP addresses of IPv4 type (version 4 of the IP protocol), the messages of the ARP protocol are directly encapsulated on Ethernet and can therefore not come leave a VLAN. However, for next hop IP addresses of IPv6 type (version 6 of the IP protocol), the messages of the ICMPv6 protocol are encapsulated in IP on Ethernet and use specific IPv6 addresses, such as LLA (Link-Local Address) or SNMA (Solicited-Node Multicast Address) the format of which defined in the RFC 4861 standard of the IETF allows them to be easily recognized by the routers to avoid treating them as IP packets. Moreover, IP packets of IPv6 type use different IPv6 addresses, known as GUA (Global Unicast Address) for which the standard format, different from the LLA or SNMA addresses, allows them to be easily recognized by the routers to authorize their transfer to other VLAN than those on which they were received.

In other words, it is possible, following another exemplary implementation and based on the abovementioned considerations, to determine whether or not an IPv6 packet includes an address resolution message, this time by carrying out a check pertaining to the destination address used (LLA and SNMA, or else GUA).

By way of illustration, an example of a check based on the type of destination addresses can consist in checking:
whether the address is of LLA or SNMA type, in which case it is an address resolution message, and no tunnel identifier should be inserted; or
if the address is of GUA type, in which case it is an IP packet, and a tunnel identifier should be inserted.

Another example of a check based on the protocol number contained in the IP header can consist in checking:
whether the standard number is assigned to the ICMPv6 protocol, in which case it is an address resolution message, and no tunnel identifier should be inserted; or
if the protocol number is not the standard number assigned to the ICMPv6 protocol, in which case it is an IP packet, and a tunnel identifier should be inserted.

Once the identifier Tunnel-ID is thus inserted, the frame TRAM_E is transmitted by the source proxy PR-S to the destination proxy PR-D1. This is the subject of a step E160 of the general method, as illustrated in FIG. 4. More particularly, said step E160 is implemented by the third transmitting module MOD_TX3-S equipping the source proxy PR-S and is an integral part, in this implementation, of said first method.

The general method then includes a step E170 of receiving, from the source proxy PR-S, the frame TRAM_E by the destination proxy PR-D1. More specifically, said step E170 is implemented by the receiving module MOD_RX-D1 equipping the destination proxy PR-D1 and is an integral part, in this implementation, of said second method.

On receiving said frame TRAM_E, the destination proxy PR-D1 checks, during a step E180 of the general method, whether the identifier Tunnel-ID, inserted between said hardware addresses CE-S MAC@, CE-D1 MAC@ and the IP packet, matches an identifier, the so-called “second identifier”, contained in a data table TAB-D1 matching the hardware address CE-D1 MAC@ of the destination host CE-D1 with said second identifier. More specifically, said step E180 is implemented by the checking module MOD_VERIF-S equipping the destination proxy PR-D1 and is an integral part, in this implementation, of said second method.

Note in this implementation, said data table TAB-D1 is stored by the destination proxy PR-D1.

Finally, if the match check between the tunnel identifier Tunnel-ID and said second identifier is positive, the destination proxy PR-D1 removes the identifier Tunnel-ID from the frame TRAM_E during a step E190. More specifically, said step E190 is implemented by the removing module MOD_DELET-D1 equipping the destination proxy PR-D1 and is an integral part, in this implementation, of said second method.

Furthermore, following the removal of the identifier Tunnel-ID, the destination proxy PR-D1 transmits the frame TRAM_E to the destination host CE-D1 during a step E200. More specifically, said step E200 is implemented by the third transmitting module MOD_TX3-D1 equipping the destination proxy PR-D1 and is an integral part, in this implementation, of said second method.

The destination IP address attached to this IP packet is denoted VPN_IP-D1@ in FIG. 4.

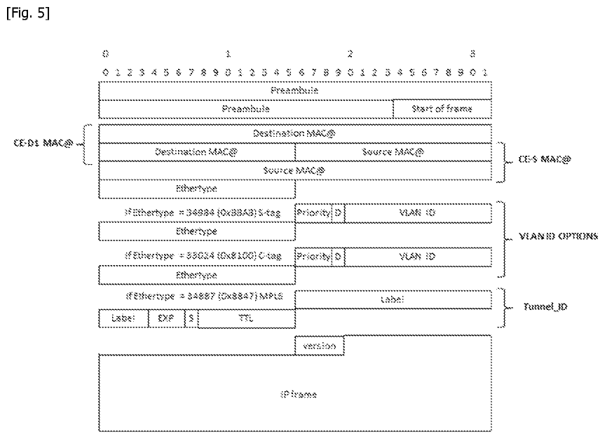

FIG. 5 schematically represents the Ethernet frame TRAM_E after the source proxy PR-S has introduced into it the tunnel identifier Tunnel-ID.

As can be seen in this FIG. 5, said identifier Tunnel-ID is placed between the hardware addresses CE-S MAC@, CE-D1 MAC@ and the IP packet (here contained in an IP frame referred to by the expression “IP frame”).

Note that the Ethernet frame TRAM_E can include as an option one or more identifiers of VLAN S-VLAN or C-VLAN type known to those skilled in the art, one or the other of which can serve as identifier to the Ethernet switches to which the computer servers SERV-1 and SERV-2 are connected, to recognize, among others, the frames to be switched within the switching virtual local network VLAN to which the proxies PR-S and PR-D1 can be connected.

Here we are describing in more detail the steps for the transmission of the frame TRAM_E. Thus, when the source host CE-S must transmit an IP packet toward the destination host CE-D1 (more specifically toward a prefix announced by the host CE-D1, this prefix corresponding to the IP address VPN_IP-D1@ mentioned above), the source host CE-S finds, in a routing table stored in its memory, the route to the prefix in question (i.e. said route can therefore be seen as a next hop IP address), then, in a resolution table which it also stores in its memory, the address CE-D1 MAC@ of the destination host CE-D1 associated with the route in question. Said source host CE-S then inserts into the IP packet in the ethernet frame TRAM_E which is then transmitted toward the address CE-D1 MAC@ of the destination host CE-D1 on the corresponding interface.

When the Ethernet frame TRAM_E is received by the virtual Ethernet bridge on the virtual interface to which the source host CE-S is attached, the source proxy PR-S adds the tunnel identifier Tunnel-ID just above the header of the IP packet by changing the IP Ethertype for an MPLS Ethertype in the original Ethernet frame TRAM_E. This latter is then transmitted by the source proxy PR-S on the VLAN associated with the virtual Ethernet bridge on the physical interface of the computer server SERV-2 hosting the destination host CE-D1. The destination proxy PR-D1 checks the consistency of the identifier Tunnel-ID and, in the event of a positive check, removes this identifier Tunnel-ID and transmits the IP packet directly in the frame Ethernet frame TRAM_E to the virtual Ethernet bridge associated with the VLAN, which transfers it toward the destination host CE-D1 through its virtual attachment interface.

In summary, the general method, and therefore particularly said first and second methods, makes it possible to define a transfer plan advantageously making it possible to connect, over the network VLAN set up through the datacenter DC, virtual Ethernet interfaces of virtual network functions defined over a plurality of private networks VPNs.

Moreover, the general method, and therefore in particular said first and second methods, has been described until now, considering the sending and receiving of an IP packet by means of an Ethernet frame, via the steps E130 to E200. It should however be noted that the implementation of these steps is optional, the general method being specifically able to be limited to the steps E10 to E120 alone.

The fact of implementing steps E10 to E120 alone already makes it possible to configure the computer system SI such that the source proxy PR-S has for only knowledge, as the next hop address, the hardware address of the source host CE-S. Since the IP address resolution requests are requests addressed to all the IP hosts on the Ethernet switching network VLAN, the source proxy PR-S can relay them without knowing the hardware address of the destination IP host. Since the IP address resolution replies are replies addressed to the hardware address of the source host CE-S, the source proxy PR-S can relay them based solely on the knowledge of the association between the hardware address of the source host CE-S and the virtual interface to which it is connected. In this way, the source host CE-S is able to find the hardware address CE-D1 MAC@ of the destination host CE-D1 without querying the source proxy PR-S and by connecting the destination host CE-D1 bearing the next hop IP address on the same VLAN as that to which the source host CE-S interface is connected.

1. A communication method implemented by a multiprotocol label switching virtual source proxy belonging to a computer system implementing a switching virtual local network, said computer system further including a virtualization management system, a first server wherein said source proxy source and a so called “host source” are connected, a second server wherein a multiprotocol label switching virtual destination proxy and a destination host are connected, said source and destination proxies being connected to the local network and also attached to a communication virtual private network, said method comprising:
running a request received from the virtualization management system to configure, on said private network, a virtual interface for said source host, said request including a request for association of a hardware address of the source host with a tunnel identifier associated with an identifier of said private network,
transmitting, to the destination proxy, a request sent by the source host, said request being an address resolution request for an IP address of the destination host, and
transmitting, to the source host, a reply to said resolution request, said reply being sent by the destination host and received from the destination proxy, and also including a hardware address of said destination host.

2. The method of claim 1, further comprising:
receiving, from the source host, an Ethernet frame encapsulating an IP packet sent by the source host toward the destination host, said Ethernet frame including the respective hardware addresses of the source and destination hosts,
inserting the tunnel identifier into the Ethernet frame between said hardware addresses and the IP packet, and
transmitting said Ethernet frame to the destination proxy.

3. The method of claim 1, wherein the tunnel identifier is identical to the identifier of the private network.

4. The method of claim 1, wherein the tunnel identifier is contained in a data table matching the identifier of said private network with said tunnel identifier.

5. A communication method implemented by a multiprotocol label switching virtual destination proxy belonging to a computer system implementing a switching virtual local network, said computer system further including a virtualization management system, a first server wherein are connected a multiprotocol label switching virtual source proxy and a source host are connected; a second server wherein said destination proxy and a destination host are connected, said source and destination proxies being connected to the local network and also attached to a communication virtual private network, said method comprising:
transmitting, to the destination host, a request received from the source proxy and sent by the source host, said request being an address resolution request for an IP address of the destination host, and
transmitting, to the source proxy, a reply to said resolution request, said reply being sent by the destination host and including a hardware address of said destination host.

6. The method of claim 5, said method further comprising:
receiving, from the source host, an Ethernet frame encapsulating an IP packet, said Ethernet frame including the respective hardware addresses of the source and destination hosts,
checking a match between, on the one hand, a first identifier, the tunnel identifier inserted between said hardware addresses and the IP packet, and a second identifier contained in a data table matching the hardware address of the destination host with said second identifier,
upon a determination that the match check is positive, removing the tunnel identifier from said Ethernet frame and transmitting the Ethernet frame to the destination host.

7. The method of claim 4, wherein a data table containing an identifier used by a proxy is a switching table stored by said proxy.

8. The method of claim 4, wherein a data table containing an identifier used by a proxy is a switching table stored by a virtual Ethernet bridge to which is connected the host contained in the server hosting said proxy.

9. A non-transitory computer readable medium having stored thereon a computer program including instructions which, when executed by a computer, cause the computer to implement the method of claim 1.

10. A non-transitory computer readable recording medium having stored thereon instructions which, when executed by a processor, cause the processor to implement the method of claim 1.

11. A multiprotocol label switching virtual source proxy including means configured to implement the method of claim 1.

12. A multiprotocol label switching virtual destination proxy, including means configured to implement the method of claim 5.

13. A computer system implementing a switching virtual local network, said computer system including a virtualization management system, a first server wherein the virtual proxy of claim 11 and a source host are connected, a second server wherein a destination host and a virtual destination proxy are connected, the virtual destination proxy including means configured to implement a method comprising:
transmitting, to the destination host, a request received from the virtual source proxy and sent by the source host, said request being an address resolution request for an IP address of the destination host, and
receiving, at the source proxy, a reply to said resolution request, said reply being sent by the destination host and including a hardware address of said destination host, said virtual source and virtual destination proxies being connected to the local network and also attached to a communication virtual private network.
